(19) United States
(12) Patent Application Publication
(10) Pub. No.: US 2008/0276706 A1
(43) Pub. Date: Nov. 13, 2008

(54) Rotation Speed Sensor

(75) Inventors: Bernhard Hartmann, Friedberg (DE); Konrad Kasper, Grafelfing (DE); Reinhard Gottinger, Neubiberg (DE); Stefan Gunthner, Frankfurt/Main (DE)

Correspondence Address: CONTINENTAL TEVES, INC., ONE CONTINENTAL DRIVE, AUBURN HILLLS, MI, 48326-1581, US

(73) Assignee: CONTI TEMIC MICROELECTRONIC GMBH, Nuernberg (DE)

(21) Appl. No.: 11/663,894

(22) PCT Filed: Sep. 27, 2005
(86) PCT No.: PCT/DE05/01773

§ 371 Date: Mar. 26, 2007

(30) Foreign Application Priority Data
Sep. 27, 2004 (DE) 10 2004 047 140.1

(51) Int. Cl. G01C 19/50

(52) U.S. Cl. 73/504.04

(57) ABSTRACT

Disclosed is a rotational rate sensor with a substrate, at least one basic element (1) which comprises a frame (2), a suspension (7) of the frame (2) on the substrate, at least one vibration facility (3) and a suspension (4, 5) of the vibration facility (3) on the frame (2), a drive device (8) and a reading facility (9, 10). The drive device (8) is designed in such a manner that it acts on the frame (2) of the basic element (1).

### BACKGROUND OF THE INVENTION

The present invention relates to a rotational rate sensor with a substrate, at least one basic element (1, 11, 12, 13, 14), which comprises a frame (2), a suspension (7) of the frame (2) on the substrate, at least one vibration facility (3) and a suspension (4, 5) of the vibration facility (3) on the frame (2), a drive means (8) and a reading facility (9, 10), whereby the drive means (8) is designed in such a manner that it acts on the frame (2) of the basic element (1, 11, 12, 13, 14).

Rotational rate sensors are commonly used in order to determine an angle speed of an object around an axis. If the rotational rate sensor is manufactured micro-mechanically on the basis of silicon substrate, it offers the advantage, as compared to a precision mechanical gyroscope, that it can be produced to very small dimensions at a relatively low cost. Further advantages are a relatively low plane of measuring uncertainty and low energy consumption during operation. An important area of application for rotational rate sensors is automobile technology, for example for driving dynamics regulation systems such as the electronic stability programme (ESP). Here, an anti-lock system, automatic brake force distribution, a drive slip control system and a yaw moment control system act together in such a manner that transverse and longitudinal stabilisation of the motor vehicle is achieved as a result of the systematic braking of individual wheels. This makes it possible to prevent the motor vehicle from rotating around its vertical axis. A further application for rotational rate sensors is the so-called rollover detection of a motor vehicle in connection with airbag control units and restraint systems for motor vehicle passengers. Furthermore, rotational rate sensors are used for navigational purposes and to determine the location and movement status of motor vehicles of all types. Other fields of application are for example image stabilisers for video cameras, the dynamic control of satellites when being ejected into the earth's orbit, or in the civil aviation sector in back-up position control systems.

Micro-mechanically produced rotational rate sensors generally comprise a vibration facility which is set by a drive into vibration. If the vibration facility moves radially inwards or outwards within a rotating system, its path speed changes. It thus experiences a tangential acceleration, which is caused by the Coriolis force. The reaction of the vibration facility to the rotation can for example be detected using a further vibration facility or other reading facilities.

A rotational rate sensor is known from the German patent document DE 196 41 284 C1, which comprises a decoupled drive and reading structure of a first and a second vibration facility, which takes the form off a spring facility. This and similar sensor configurations known from the prior art, and which are based on the Coriolis effect, have the disadvantage that as a result of the decoupling required here, a passive, inert mass is generated which in turn reduces the measuring sensitivity, since the Coriolis force is unable to act on the passive mass.

The international publication WO 03/104823 A1 discloses a multiple-axis, monolithic acceleration sensor with up to four seismic masses, which take the form of paddles, and which are suspended via torsion springs on a frame. With this sensor, accelerations in the direction of the respective primary sensitivity axes can be measured, but no rotational rates.

The object of the present invention is to maximise the sensitivity of the rotational rate sensor to acting Coriolis forces. Here in particular, the aim is also to create drive and reading structures which are as independent as possible.

### SUMMARY OF THE INVENTION

This object is attained by means of the invention using a rotational rate sensor with a substrate, at least one basic element, which comprises a frame, a suspension of the frame on the substrate, at least one vibration facility and a suspension of the vibration facility on the frame, a drive means and a reading facility, whereby the drive means is designed in such a manner that it acts on the frame of the basic element, or the entire basic element is triggered to start vibrating via the frame.

In this way, according to the invention, all movable structures are triggered to start vibrating in the drive direction, including the vibration facilities which are sensitive to Coriolis forces, but which possess an additional degree of freedom of movement. As compared to the prior art, dormant or passive masses are thus no longer generated which reduce the sensitivity of the rotational rate sensor, due to the fact that the Coriolis force cannot act on dormant or passive masses.

Here, the frame of the basic element is essentially only executed in such a manner as to be movable on a plane which is spanned by the substrate. In the vertical direction to this, the frame is therefore essentially rigid. The vibration facility is designed in such a manner that it preferably executes a movement which is vertical to the drive movement. When suitable suspensions of the vibration facility are selected, the drive movement cannot essentially trigger movements along its degree of freedom of movement. In the same way, the vibration facility cannot interfere with the drive movement as a result of its movements. In other words, the sensing movement of the vibration facility is decoupled from the drive movement of the frame. This is the preferred embodiment of the present invention. The fact that the sensitivity direction of the reading facility is essentially vertical to the acting direction of the drive means is in particular an advantage.

In particular, each basic element comprises a separate drive means, so that each basic element can be driven or triggered to start vibrating independently of other basic elements. A coupling between different basic elements is thus not absolutely necessary.

Preferably, the drive means takes the form of a drive comb with capacitive triggering. However, it is also possible for the triggering or drive to be electrical, thermal, magnetic, piezo-electric or to use some other means.

The vibration facility preferably takes the form of a seismic mass, in particular in the form of a paddle. Springs are preferably provided for the purpose of suspending the vibration facility on the frame and of suspending the frame on the substrate. The suspension of the vibration facility is here preferably achieved using springs which take the form of torsion or bending beams.

Particularly advantageously, the (resonance) frequencies of the frame and the vibration facility can be adjusted independently of each other using the springs, since the springs are independent of each other and do not essentially influence each other.

Particularly advantageously, the rotational rate sensor comprises at least two basic elements which are connected with each other via a coupling unit. The coupling is here preferably designed in such a manner that the basic elements only influence each other slightly in their movement. The basic elements are preferably turned towards each other by 180° (with two basic elements) or by 90° (with four basic elements), so that they can be triggered to start counter-phase vibrations, as a result of which the centre of gravity of the system remains still. Via the coupling, the basic elements can then comprise a shared resonance frequency.

Although the basic elements generally only influence each other slightly in their movement, it can be advantageous that with basic elements which are located opposite each other and which vibrate in a counter-phase manner, the coupling unit also triggers or forces the basic elements which are arranged so that they are turned by 90° to them to vibrate in a counter-phase manner.

Preferably, the coupling unit takes the form of a ring or circle and is suspended adjacent to the shared centre of gravity of the basic elements.

Particularly advantageously, at least two reading facilities are provided so that two rotational movements can be sensed or detected in different directions. A reading facility then preferably comprises movements of the frame on the plane spanned by the substrate and vertical to the acting direction of the drive means, and the other reading facility detects movements of the vibration facility which are vertical to the plane spanned by the substrate.

### BRIEF DESCRIPTION OF THE DRAWINGS

In the drawings:

FIGS. 1a-c illustrate embodiments of basic element 1;

FIG. 2 shows an embodiment of a rotational rate sensor;

FIG. 3 shows an exemplary embodiment of a multiple-axis x/y rotational rate sensor;

FIG. 4 shows a multiple axis x/z rotational rate sensor;

FIG. 5 shows an example of a reading facility for recording a movement of a mass.

### DETAILED DESCRIPTION OF THE DRAWINGS

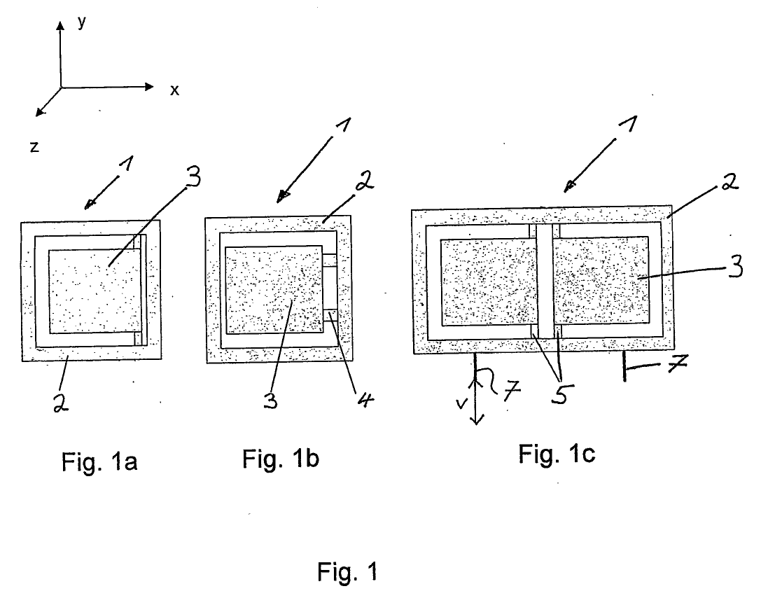

In FIG. 1, which contains three individual FIGS. 1a to 1c, different embodiments of basic elements 1 are shown, which can be used in the present invention. A micro-mechanically produced rotational rate sensor commonly comprises several components. A substrate, which is not shown in the Figure, which can for example be a silicon wafer, comprises in particular a smooth surface.

At least one basic element 1 is provided on or in the substrate, and comprises one or more vibration facilities 3. According to the present invention, the vibration facilities preferably take the form of seismic masses, which are suspended in a frame 2. This suspension can for example be achieved via torsion beams 5 or bending beams 4. Bending beams 4 have a linear spring characteristic curve, however, the seismic masses 3 of the rotational rate sensor according to the invention are preferably fastened on the frame 2 using torsion beams 5. According to FIG. 1c, the basic element 1 can comprise one or more seismic masses 3, for example, two paddles 3 with an opposite suspension 5.

The suspension 4, 5 only permits a movement of the centre of gravity of the seismic mass 3 in the z-direction, vertical to the plane of the frame 2. The plane of the frame 2 is parallel to the substrate, or to the plane spanned by the substrate (x/y plane).

As is shown in FIG. 1c, the basic element 1 is fastened by one or more further suspensions 7 on the substrate, which is not shown. The suspension 7 is preferably formed by springs. These permit a movement of the basic element 1 in the y direction of a first axis (y axis), parallel to the substrate. In this exemplary embodiment, the springs are essentially designed so as to be rigid in the x and z directions, vertical to the first axis (y axis). According to exemplary embodiments described below, it is however also possible that the suspension 7 is only rigid in one direction z. According to the preferred embodiment of the present invention, the frame 2 of the basic element 1 is in all cases only moveable on the plane which is spanned by the substrate (x/y plane).

The rotational rate sensor furthermore comprises at least one exciter or drive means, not shown in FIGS. 1a to 1c. The drive means is a device which can trigger the basic element 1 to start vibrating along the first axis (y axis). This can be achieved electrically, thermally, magnetically, piezo-electrically or in another suitable manner.

Finally, the rotational rate sensor also comprises at least one reading facility (not shown in FIGS. 1a to 1c). This is a device which measures a deflection of the vibration facility or the seismic mass vertical to the plane (x/y plane) of the frame 2, i.e. in the z direction. The reading facility can for example be based on a capacitive, piezo-resistive, magnetic, piezo-electric or optical measuring principle.

The general functional principle of the rotational rate sensor will now be described in brief below. The basic element 1 or the frame 2 is triggered to vibrate periodically along the first axis (y axis). When a rotational movement of the vibration facility or the seismic mass 3 occurs around the second axis (x axis; on the substrate plane, and vertical to the first axis), a Coriolis force occurs vertically to the first and the second axis, i.e. in the direction z of the third axis. The Coriolis force acts both on the frame 2 and on the seismic mass or vibration facility 3 suspended there. The frame 2 is however rigid in the z direction, so that only the seismic mass 3 is deflected along this axis. This deflection is detected by the detection or reading facility, and is a measure for the rotational speed which has been reached.

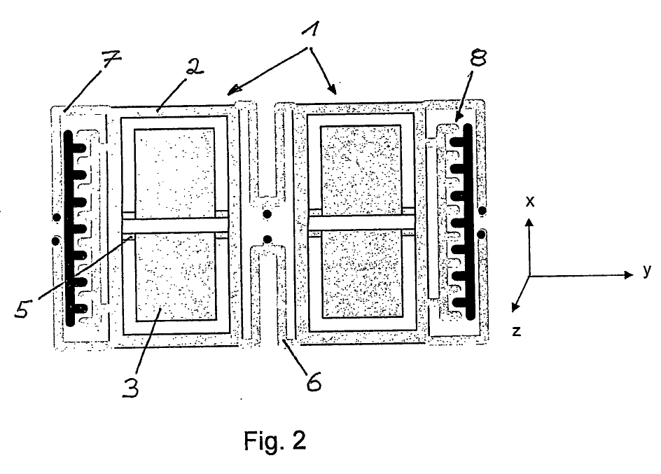

In connection with FIG. 2, and explained in different terms, an essentially rigid frame 2 is triggered in the y direction of the drive means 8 and is preferably only moveable in this direction y. This movement is transferred to the seismic mass 3 which is only gently suspended in the reading direction z (vertical to the triggering direction y). As a result, the seismic mass 3 remains essentially dormant during the drive movement itself. The Coriolis force moves only the seismic mass 3, while the moved frame 2 is essentially rigid in this direction. The drive movement is thus essentially not interfered with. Conversely, the drive movement does not essentially influence the signal reading of the reading facility (not shown in FIG. 2); the reading movement therefore in principle has no feedback to the drive movement.

The triggering is preferably achieved by means of capacitive comb structures (FIG. 2) which take the form of drive means 8, but could also however be achieved for example by means of piezo resistances in the suspension of the seismic mass 3 (not shown), whereby then, the stress in the suspension 5 would be measured during a deflection. The reading is then achieved for example capacitively using counter-electrodes which are arranged at a defined distance from the seismic mass 3.

According to the invention, the drive means 8 directly or indirectly acts on the frame 2 of the basic element 1, or via the frame 2, the entire basic element 1 is triggered to start vibrating. In this manner, all moveable structures in the drive direction y are triggered to start vibrating, including those vibration facilities 3 which are sensitive to Coriolis forces, but which still have a further degree of freedom of movement. As compared to the prior art, there are thus no longer any dormant or passive masses which reduce the sensitivity of the rotational rate sensor due to the fact that the Coriolis force cannot act on dormant or passive masses.

FIG. 2 shows an exemplary embodiment of a rotational rate sensor according to the invention with two coupled basic elements 1 which are turned by 180°, each with two seismic masses 3, which are triggered to start counter-phase vibrations. This has the following advantage. Due to the counter-phase vibration of the two symmetrically arranged basic elements 1, the entire centre of gravity of the system remains dormant; ideally, no energy acts on the chip structure. Linear accelerations (such as vibrations) in the direction of the z axis can be eliminated by differential signal evaluation. Vibrations in the x direction have no effect on the operation of the rotational rate sensor, due to the high degree of rigidity of the suspension used. A coupling unit 6 between the basic elements 1 forces a shared resonance frequency of the two basic elements 1 for counter-phase movements in the y direction.

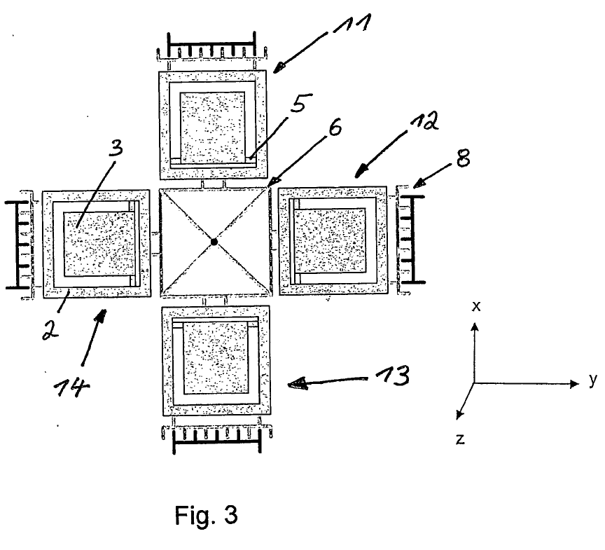

FIG. 3 shows an exemplary embodiment of a multiple-axis x/y rotational rate sensor according to the invention. In other words, a rotational direction in the x and y directions can thus be detected. Here, four basic elements 11, 12, 13, 14, which are turned towards each other by 90°, are coupled in such a manner that in each case two basic elements 11, 13 or 12, 14 are capable of vibrating in one direction, x or y, in an anti-phase. The two directions of vibration, x, y, lie on one plane and are positioned vertically on top of each other. The selected coupling unit 6 supports counter-phase vibration behaviour of the vibration facilities or seismic masses 3. In the case of this arrangement, the basic elements 12, 14 which are arranged along the y direction move both towards each other and towards the basic elements 11, 13, which are arranged in the y direction, with a phase shift of 180°. From the phase relation of the reading facility not shown to the signals of the drive facilities 8, a rotational direction can also be detected and differentiated which lies on the substrate plane and between the precise x and y directions.

In particular, each basic element 11, 12, 13, 14 comprises a separate drive means 8, so that each basic element 11, 12, 13, 14 can be driven or triggered to start vibrating independently of other basic elements 11, 12, 13, 14. A coupling unit 6 between different basic elements 11, 12, 13, 14 is thus not absolutely necessary, although it does however comprise the advantages described above.

Preferably, the coupling unit 6 takes the form of a ring or a circle and is suspended adjacent to the shared centre of gravity of the basic elements 11, 12, 13, 14.

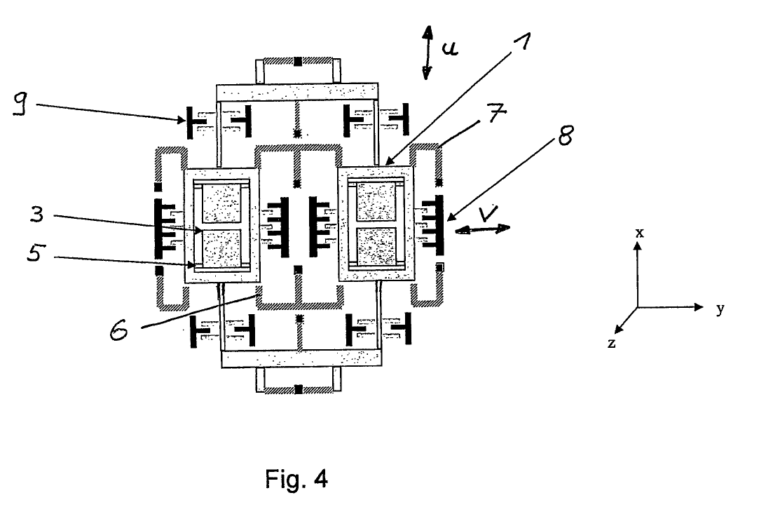

FIG. 4 shows as a further exemplary embodiment of the present invention a multiple axis x/z rotational rate sensor. Based on the single-axis rotational rate sensor described in FIG. 2, a dual-axis rotational rate sensor with the sensitivity directions x and z can be realised by this exemplary embodiment. Two basic elements 1 are here suspended with a system of suspensions 7 which take the form of springs in such a manner that they are moveable both in the y direction and in the x direction. The basic elements 1 are triggered to start counter-phase vibrations along the y direction via drive means 8 which take the form of capacitive structures or drive combs.

The x sensor functions as follows. When a rotational rate occurs in the x direction, the seismic masses or paddles 3 which are suspended in the basic element 1 are subjected to a force in the z direction. The tilt around the suspension or torsion beam 5 which then occurs is detected as a capacity change using a reading facility not shown in FIG. 4 which can for example be formed via electrodes which are positioned over it.

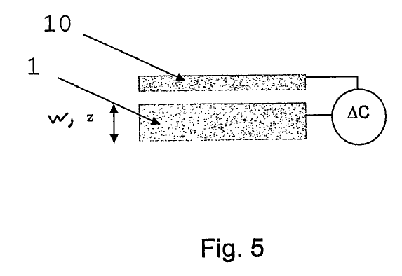

FIG. 5 shows for example a reading facility 10 of such a type that the movement of the seismic mass 3 can be recorded by means of capacity changes Δc. Here, a counter-electrode is provided, which is affixed to the substrate.

Let us return to FIG. 4, according to which the z sensor operates as follows. A rotational rate in the z direction creates a displacement of the basic element 1 in the x direction. This displacement is detected using a reading facility 9 which takes the form of capacitive comb structures. A most particularly advantageous arrangement is given when on each basic element 1 two reading facilities 9 are attached which are turned by 180°. In this manner, the differential signal can be evaluated for each basic element 1.

The particular advantage of the embodiment according to the invention shown in FIG. 4 is a result of the following. Due to the arrangement shown, a rotational rate in the x direction and a rotational rate in the z direction can be measured simultaneously. The reading facilities 9, 10 on these two axes are essentially decoupled. Due to the use of differential reading principles, linear accelerations along the x or the z axis can be essentially suppressed or offset. The dual-axis embodiment of the rotational rate sensor according to the invention can also be achieved with relatively small dimensions, since for both detection axes or directions of sensitivity, u, w of the reading facilities 9, 10 the same basic elements 1 can be used.

For all exemplary embodiments, the suspensions or springs 4, 5, 7 which determine the resonance frequency of the triggering movement of the frame 2 and the reading movement of the seismic mass or vibration facility 3 can be designed in such a manner as to be essentially independent of each other. In a particularly advantageous manner, the frequencies can also thus be adjusted independently of each other.

With the exemplary embodiments with at least two basic elements 1, the suspensions 4, 5, 7 of the seismic masses 3 and the frame 2 can also preferably be selected in such a manner that a low-plane coupling of the movement of the seismic mass or vibration facility 3 is present in the second basic element 1. The movements of the two seismic masses 3 are thus not completely independent of each other, so that two shared resonance frequencies of the two basic elements are adjusted. In a utilisation mode which is triggered by acting Coriolis forces, the seismic masses 3 of the basic elements 1 vibrate with a phase shift of 180° to each other. A parasitic mode, which represents the cophasal vibration (0° phase shift) of the seismic masses or vibration facilities 3, lies in a different frequency range and can be eliminated using suitable filtering. As a result, signals can be suppressed which are caused by low asymmetries between the basic elements 1 which are coupled in this manner.

### List of Reference Numerals

1 Basic element
2 Frame
3 Vibration facility or seismic mass
4 Suspension or bending beam
5 Suspension or torsion beam
6 Coupling unit
7 Suspension of the frame on the substrate
8 Drive means
9 Reading facility
10 Reading facility
11 Basic element
12 Basic element
13 Basic element
14 Basic element
Δc Capacity change
u Sensitivity direction of a reading facility
v Effective direction of the drive means
w Sensitivity direction of a reading facility
x Direction (substrate plane)
y Direction (substrate plane)
z Direction (vertical to the substrate plane)

1-16. (canceled)

17. A rotational rate sensor comprising:
a substrate,
at least one basic element (1, 11, 12, 13, 14) which comprises a frame (2) and a suspension (7) of the frame (2) on the substrate;
at least one vibration facility (3) and a suspension (4, 5) of the vibration facility (3) on the frame (2);
a drive means (8); and
a reading facility (9, 10), wherein the drive means (8) is designed to act on the frame (2) of the basic element (1, 11, 12, 13, 14).

18. A rotational rate sensor according to claim 17, wherein the frame (2) of the basic element (1, 11, 12, 13, 14) is essentially only moveable on a plane (x/y plane) spanned by the substrate.

19. A rotational rate sensor according to claim 17, wherein each basic element (1, 11, 12, 13, 14) comprises a separate drive means (8).

20. A rotational rate sensor according to claim 17, wherein the drive means (8) takes the form of a drive comb with capacitive triggering.

21. A rotational rate sensor according to claim 17, wherein the vibration facility (3) takes the form of a seismic mass, in particular in the form of a paddle.

22. A rotational rate sensor according to claim 17, wherein a sensitivity direction (u, w) of the reading facility (9, 10) is essentially vertical to the effective direction (v) of the drive means (8).

23. A rotational rate sensor according to claim 17, wherein the suspension (4, 5) of the vibration facility (3) and the suspension (7) of the frame (2) take the form of springs.

24. A rotational rate sensor according to claim 17, wherein the resonance frequencies of the frame (2) and the vibration facility (3) can be adjusted independently of each other using the springs (4, 5, 7).

25. A rotational rate sensor according to claim 17, wherein the rotational rate sensor comprises at least two basic elements (1, 11, 12, 13, 14), which are connected with each other via at least one coupling unit (6).

26. A rotational rate sensor according to claim 25, wherein the basic elements (1, 11, 12, 13, 14) comprise a shared resonance frequency.

27. A rotational rate sensor according to claim 25, wherein the rotational rate sensor comprises four basic elements (11, 12, 13, 14) which are turned towards each other by 90°.

28. A rotational rate sensor according to claim 27, wherein the basic elements (11, 12, 13, 14) are located opposite and vibrate in a counter-phase manner, the coupling unit (6) triggers the basic elements (12, 14) which are in each case turned towards them by 90° to start counter-phase vibrations.

29. A rotational rate sensor according to claim 25, wherein the coupling unit (6) takes the form of a ring or circle and is suspended adjacent to the shared centre of gravity of the basic elements (1, 11, 12, 13, 14).

30. A rotational rate sensor according to claim 25, wherein at least two reading facilities (9, 10) are provided on the rotational rate sensor.

31. A rotational rate sensor according to claim 30, wherein a reading facility (9) detects movements (u) of the frame (2) on the plane spanned by the substrate and vertical to the effective direction (v) of the drive means (8), and the other reading facility (10) detects movements (w) of the vibration facility (3) vertical to the plane spanned by the substrate.

32. A rotational rate sensor according to claim 30, wherein on each frame (2) two reading facilities (9) are provided which are turned towards each other by 180°.
